(19) United States
(12) Patent Application Publication
(10) Pub. No.: US 2014/0037881 A1
(43) Pub. Date: Feb. 6, 2014

(54) FAULT-RESPONSIVE INDICATOR BEAD

(71) Applicant: Norman G. Schabel, JR., Rocky River, OH (US)

(72) Inventor: Norman G. Schabel, JR., Rocky River, OH (US)

(73) Assignee: SCHABEL POLYMER TECHNOLOGY, LLC, Rocky River, OH (US)

(21) Appl. No.: 13/751,816

(22) Filed: Jan. 28, 2013

Related U.S. Application Data
(60) Provisional application No. 61/591,256, filed on Jan. 26, 2012.

(51) Int. Cl. F16S 5/00

(52) U.S. Cl. CPC F16S 5/00
USPC 428/36.92; 428/402.21; 428/402.24; 428/327; 428/221; 252/408.1; 252/182.13

(57) ABSTRACT

Fault-responsive indicator beads (10) are provided for integration into the system of a substrate such as a coating structure, a vehicle, a garment, or a package part. Each bead (10) comprises a shell (11) designed to fracture when the system encounters a fault condition. A core (12), within the shell (11), contains a material which is dormant when the shell (11) is intact and functional when the shell (11) is fractured.

### RELATED APPLICATION

This application claims priority under 35 USC §119(e) to U.S. Provisional Patent Application No. 61/591,256 filed on Jan. 26, 2012. The entire disclosure of this provisional patent application is hereby incorporated by reference.

### BACKGROUND

Structures, vehicles, garments, packaging, and other substrates are often vulnerable to integrity-compromising conditions. These conditions can be caused by, for example, unexpected impact, internal or external pressure, deliberate tampering, unacceptable temperature, stress, strain, dislocation, deformation, and/or distortion.

### SUMMARY

A fault-responsive bead is provided which contains a material that is dormant in pre-fault condition and functional in a post-fault condition. The material can be an indicator signifying that a fault has occurred and/or the material can be a remedy helping to mitigate the consequences of the fault.

### DRAWINGS

FIGS. 1A-1B each show a fault-responsive bead.

FIGS. 2A-2B, FIGS. 3A-3B, and FIGS. 4A-4B each show a substrate incorporating a plurality of the fault-responsive beads.

### DESCRIPTION

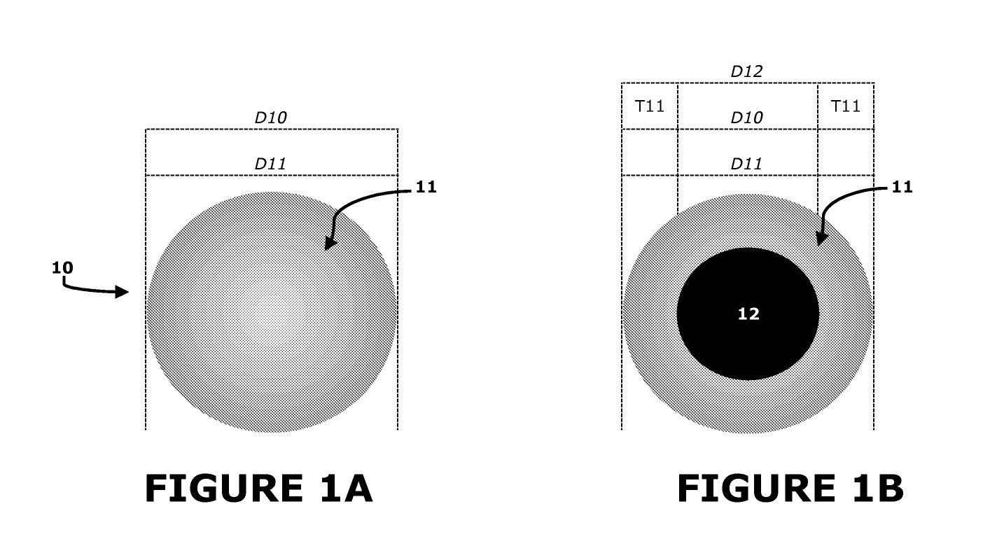

Referring now to the drawings, and initially to FIGS. 1A-1B, a fault-responsive bead 10 comprises an exterior shell 11 and an interior core 12. When the shell 11 is intact, the core 12 is completely enclosed and, when the shell 11 is fractured, the core 12 is exposed. The fault-responsive bead 10 can be made by encasing a core-forming droplet in a heated polymer which when cooled forms the shell 11.

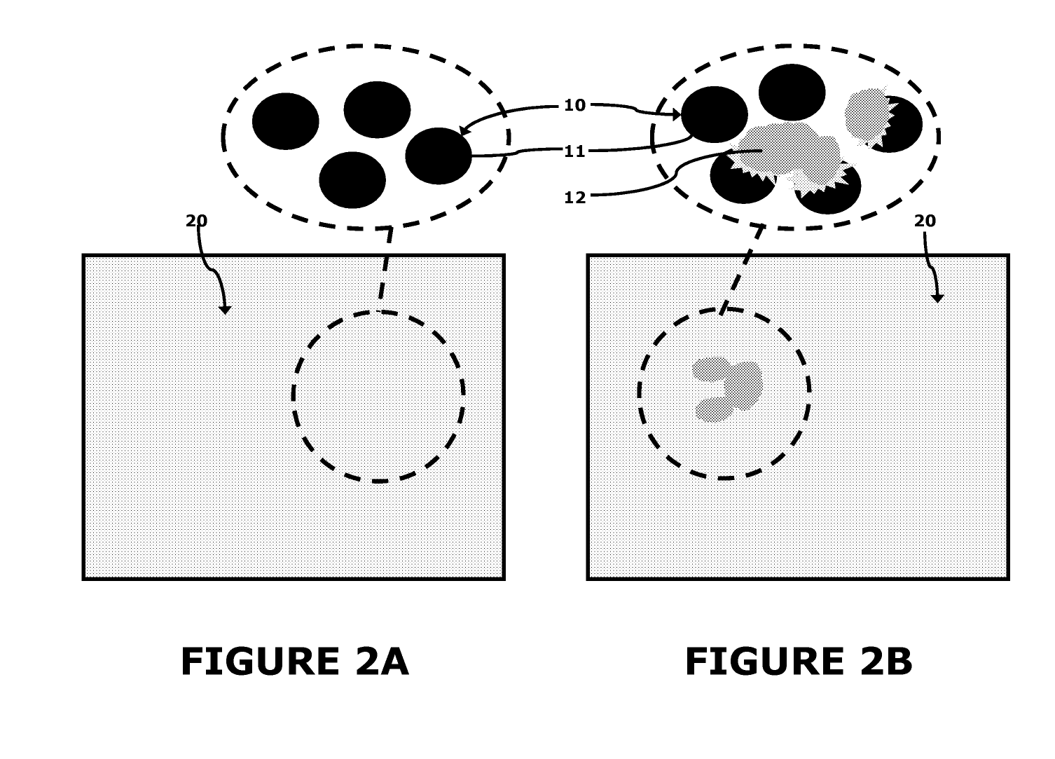

Referring now to FIGS. 2A-2B, the fault-responsive beads 10 are shown integrated into a substrate 20. The substrate 20 can comprise, for example, a structure (e.g., pipelines, process equipment, storage tanks, cables, etc.), a vehicle (e.g., aircraft, watercraft, trains, automobiles,) a garment (e.g., sterilization suits, protective gloves, etc.), and/or a package part (e.g., containers, labels, tapes, etc.). In FIG. 2A, the substrate 20 is shown in an intact condition wherein the beads' shells 11 are intact and the core 12 is completely enclosed. In the post-fault condition shown in FIG. 2B, the shells 11 in the affected region are fractured to expose the core 12.

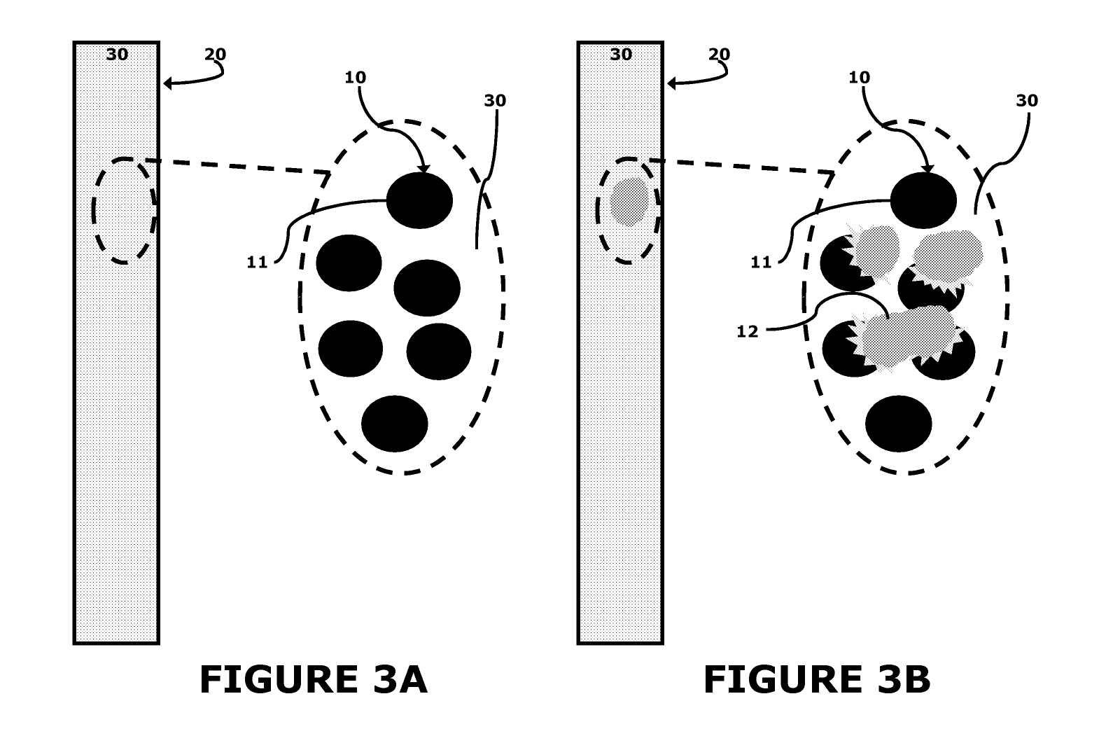

As shown in FIGS. 3A-3B, the fault-responsive beads 10 can be integrated into the substrate 20 via incorporation directly into the main substrate body 30. In this case, for example, the beads 10 can be dispersed within the substrate-making material during initial formation.

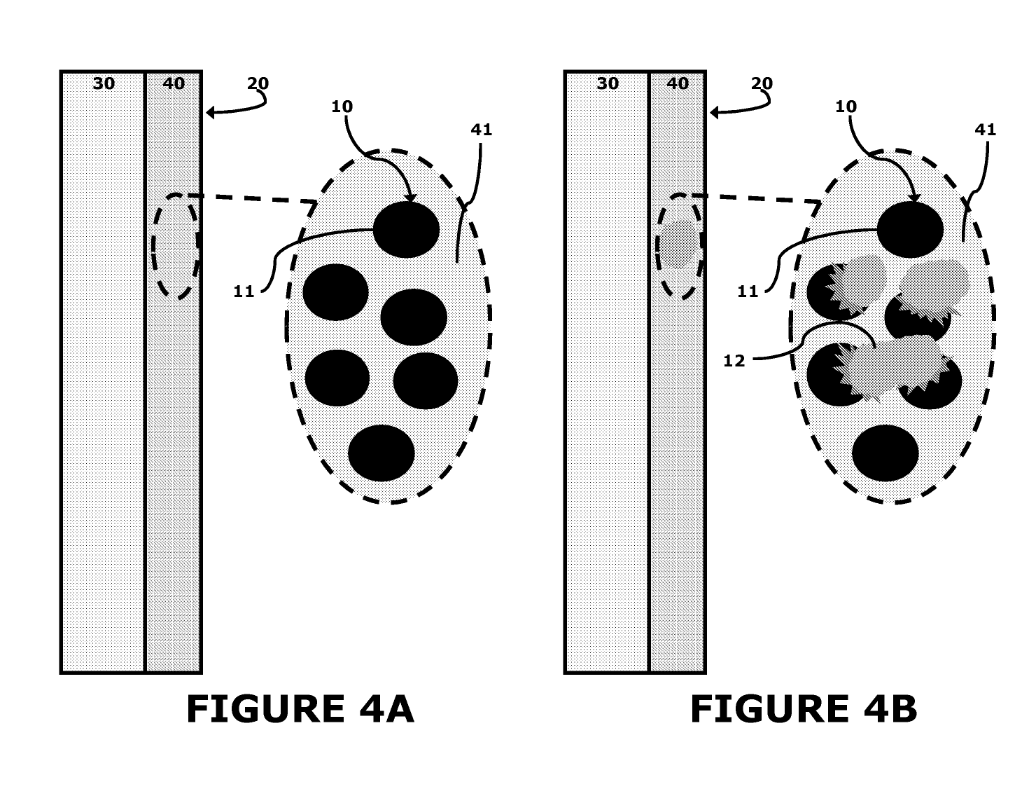

As shown in FIGS. 4A-4B, the fault-responsive beads 10 can be integrated into the substrate 20 via a coating layer 40 situated on the main substrate body 30. In this case, for example, the beads 10 can be dispersed within a coating fluid and/or resin 41 which is applied to a surface of the substrate body 30.

In the illustrated embodiments, the bead 10, the shell 11, and the core 12 are all substantially spherical in shape. The shell's diameter D11 defines the bead's diameter D10, and the shell's thickness T11 is defined by the difference between its diameter D11 and that core's diameter D12.

The beads 10, the shells 11, and/or the cores 12 can be any suitable size to optimize performance and fault-indicating purposes. Larger diameters (e.g., 1 to 8 mm) may be best suited when the beads 10 are incorporated into the substrate body 30. Smaller bead sizes (e.g., 1 to 100 microns) may be best suited when the beads 10 reside in a thin film coating layer 40. And intermediate bead sizes (e.g., 100 microns to 3 mm) might be the best candidates when the beads 10 are occupants of a thick adhesive or paste coating.

The shell's thickness T11 (i.e., the difference between its diameter D11 and the core diameter D12) and/or the shell material composition can be tailored to provide the appropriate rupture trigger, fracture mechanism, and/or fracture strength.

The beads' shells 11 can also be adapted to be essentially unnoticeable in the pre-fault condition. Specifically, for example, the shells 40 can be an opaque color blending with the color of the substrate body 30 (if incorporated therein) or the coating layer 40 if incorporated therein. Thermoplastic and/or thermoset resins (e.g., poly oxy methylene urea (pmu), urea formaldehyde, phenolic, epoxy, polyester, polyethylene, polypropylene, polyamide, etc.) can be considered suitable candidates for shell materials.

The core 12 can comprise an indicating material such as a pigment mixture adapted to be incompatible (e.g., insoluble) with the surrounding medium so as to flow in a fault-indicating manner. The pigment color can be contrasting with that of the substrate body 30 and/or the coating fluid 41. Additionally or alternatively, the indicator 12 can be activated and/or detected by heat, light, radiation, infrared, electrical fields, orientation, oxidation or other effect mechanisms.

The indicator core 12 could instead comprise a substance such as reactive chemicals, charged or conductive particles, metallic particles, charge-inhibiting particles, thermochromic pigments, or other marker materials.

The indicator core 12 can additionally or alternatively include a remedial substance (e.g., a self-sealing resin, disinfectant, neutralizing agent, chemical additive, etc.).

Although the beads 10, the substrate 20, the substrate body 30, and/or the coating layer 40, have been have been shown and described as having certain forms and fabrications, such portrayals are not quintessential and represent only some of the possible adaptations of the claimed characteristics. Other obvious, equivalent, and/or otherwise akin embodiments could instead be created using the same or analogous attributes.

1. A fault-responsive bead for integration into a substrate of a system, wherein said bead comprises:
a shell designed to fracture when the system encounters a fault condition; and
a core containing a material which is dormant when the shell is intact and functional when the shell is fractured.

2. A fault-responsive bead as set forth in claim 1, wherein the shell has a wall thickness and/or a material composition tailored to fracture at predetermined fault condition.

3. A fault-responsive bead as set forth in claim 2, having a particle size of between 1 and 100 microns.

4. A fault-responsive bead as set forth in claim 2, having a particle size of between 100 microns and 3 mm.

5. A fault-responsive bead as set forth in claim 2, having a particle size of between 1 mm and 8 mm.

6. A fault-responsive bead as set forth in claim 2, wherein the shell is made from thermoplastic and/or thermoset resins.

7. A fault-responsive bead as set forth in claim 1, wherein the fault condition involves impact on the substrate.

8. A fault-responsive bead as set forth in claim 1, wherein the fault condition involves pressure on the substrate.

9. A fault-responsive bead as set forth in claim 1, wherein the fault condition involves temperature of the substrate.

10. A fault-responsive bead as set forth in claim 1, wherein the fault condition involves stress or strain on the substrate.

11. A fault-responsive bead as set forth in claim 1, wherein the fault condition involves dislocation, deformation and/or distortion of the substrate.

12. A fault-responsive bead as set forth in claim 2, wherein the material is an indicating material which is undetectable when the shell is intact and detectable when the shell is fractured.

13. A fault-responsive bead as set forth in claim 2, wherein the material is a resolving material which is latent when the shell is intact and remedial when the shell is fractured.

14. A fault-responsive bead as set forth in claim 2, wherein the material is an indicating material which is undetectable when the shell is intact and detectable when the shell is fractured; and/or a resolving material which is latent when the shell is intact and remedial when the shell is fractured.

15. A substrate integrating a plurality of the beads set forth in claim 14.

16. A substrate as set forth in claim 15, comprising a coating structure, a vehicle, a garment, or a package part.

17. A substrate as set forth in claim 15, in a pre-fault condition wherein the beads' shells are intact and their cores are completely enclosed.

18. A substrate as set forth in claim 15, in a post-fault condition wherein at some of the beads' shells are fractured and their cores are functional.

19. A substrate as set forth in claim 15, wherein the beads are incorporated directly into the main substrate body.

20. A substrate as set forth in claim 15, wherein the beads are incorporated into a coating layer situated on the main substrate body.
